(19) United States
(12) Patent Application Publication
(10) Pub. No.: US 2014/0352963 A1
(43) Pub. Date: Dec. 4, 2014

(54) Powder Defoaming Compositions and Methods of Reducing Gas Entrainment In Fluids

(71) Applicants: Amir H. Mahmoudkhani, Atlanta, GA (US); Robert Wilson, Marietta, GA (US); Frederique Cocquerelle, Aspach le Bas (FR); Lucianna Bava, Dunwoody, GA (US)

(72) Inventors: Amir H. Mahmoudkhani, Atlanta, GA (US); Robert Wilson, Marietta, GA (US); Frederique Cocquerelle, Aspach le Bas (FR); Lucianna Bava, Dunwoody, GA (US)

(21) Appl. No.: 14/125,321

(22) PCT Filed: Jun. 15, 2012
(86) PCT No.: PCT/US12/42714

§ 371 Date: Aug. 7, 2014

Related U.S. Application Data
(60) Provisional application No. 61/498,138, filed on Jun. 17, 2011.

(51) Int. Cl. C09K 8/467; E21B 33/14; B01D 19/04

(52) U.S. Cl. CPC C09K 8/467; B01D 19/0495; E21B 33/14; C04B 24/281
USPC 166/292; 516/116; 106/810

(57) ABSTRACT

Powder defoaming compositions comprising one or more water soluble alkali salts, and one or more defoaming agents. Also disclosed are compositions including flowable materials and a defoaming composition, and methods for reducing the amount of gas present in a fluid using said defoaming compositions.

### CROSS-REFERENCE TO RELATED APPLICATION

This application claims priority to U.S. Provisional Application No. 61/498,138, filed Jun. 17, 2011, which is incorporated by reference in its entirety.

### FIELD OF THE ART

The present disclosure generally relates to powder defoaming compositions and methods for reducing or preventing or breaking foam or entrainment of gas in oil and gas well treatment fluids.

### BACKGROUND

Defoaming compositions and agents have long been used in the oil and gas industry to prevent the formation of foam or to destroy previously formed foam. The defoaming compositions are commonly utilized as components in well treating fluids to prevent the formation of foam during the preparation and/or pumping of the treating fluids. Such treating fluids include: drilling muds, spacer fluids, cement slurries, fracturing fluids and so on. Also, defoaming compositions have been utilized heretofore for breaking previously formed foamed well treating fluids. That is, when a stable foamed well treating fluid must be disposed of on the surface, a defoaming composition is added to the fluid to destroy the foam whereby the non-foamed components of the treating fluid can be readily disposed of

A variety of defoaming compositions has been utilized in upstream oilfield applications. There are two general classes of defoaming agents commonly used for well treatment fluids: silicones and non-silicone based compositions and are available in either liquid or powder forms. Defoaming compositions may be added at different stages to well treatment fluids. For preparation of fluids, liquid defoamers are often added to water prior to or after the addition of any solids, while powder (also called dry or solid) defoamers may be dry-blended with solids of a composition prior to the addition of water or other fluids.

Although liquid defoamers are predominantly used in common operating conditions, powder defoamers are preferred, mainly due to ease of handling and storage, particularly in extreme climates such as in Canada and Russia. Powder defoamers are mixtures which have the appearance of solid or flowable powder where the active ingredients, often a liquid defoamer, is supported by a suitable solid inorganic or organic carrier. As compared to liquid defoamers, powder defoamers have better long term stability and uniformity and provide the option of preparing pre-mixed solids.

Powder defoamers are commonly prepared by adsorption of active defoaming chemistry on a solid carrier often chosen from high surface area solid materials. Products such SIPERNAT® 22 (Evonik Industries AG) and TIXOSIL® 68 (Rhodia) are commercially available fine silica powders with high adsorption capacities for liquids. These products can typically adsorb oil up to 2.5 times of their weight.

It is generally thought that higher liquid uptake by the carrier results in higher performance of dry defoamer. Nevertheless, dry defoamers often show lower activities compared to the active defoamer in its liquid form at the same dosage. Therefore, oil and gas service companies tend to use a supplementary liquid defoamer when the dry defoamer is unable to provide adequate performance during mixing in field operations.

Lower activity of a dry defoamer may be attributed in part to poor/slow desorption/release kinetics of the active defoamer from the carrier surface and thus inaccessibility to the foaming media. In the case of high surface area carriers, it is likely that a major part of active defoamer is either strongly adsorbed at the surface of silica or trapped within the pores and channels and cannot be immediately released upon addition to the foaming media.

U.S. Patent Publication No. 2008/0280786 A1 (incorporated herein by reference) describes a solid defoamer/antifoamer composition which comprises one slightly soluble defoaming compound, and one emulsifier.

The description herein of certain advantages and disadvantages of known methods and compositions is not intended to limit the scope of the present disclosure. Indeed the present embodiments may include some or all of the features described above without suffering from the same disadvantages.

### BRIEF SUMMARY

Exemplary embodiments described herein include a defoaming composition comprising one or more water soluble alkali salts and one or more defoaming agents.

At least one embodiment provides a composition comprising a flowable material and a defoaming composition comprising one or more water soluble alkali salts and one or more defoaming agents.

At least one embodiment provides a method for reducing an amount of entrained gas present in a flowable material, comprising adding a defoaming composition to the flowable material, wherein the defoaming composition comprises one or more water soluble alkali salts and one or more defoaming agents.

At least one embodiment provides a method for preventing foaming in cement or a cementitious material, comprising adding a defoaming composition to the cement or cementitious material, wherein the defoaming composition comprises one or more water soluble alkali salts and one or more defoaming agents.

At least one embodiment provides a method of cementing in a subterranean formation, wherein the method comprises displacing a cement composition into a subterranean formation, and allowing the cement composition to set. The cement composition comprises one or more hydraulic cements, water and a defoaming composition comprising one or more water soluble alkali salts and one or more defoaming agents.

### BRIEF DESCRIPTION OF THE FIGURE

FIG. 1 shows the compressive strength development as a function of time for a cement slurry with a defoamer composition according to the exemplary embodiments.

### DETAILED DESCRIPTION

Described herein are various exemplary embodiments including defoaming compositions, compositions including such defoaming compositions, and methods for reducing the amount of gas present in a fluid. The exemplary defoaming compositions are powder compositions that include one or more water soluble alkali salts and one or more defoaming agents. The exemplary defoaming compositions offer enhanced water solubility as compared to other commercially available dry defoaming compositions. Upon contact with water, the active defoaming agents in the composition are released.

According to various exemplary embodiments, the defoaming compositions can be included in various flowable materials, for example cement, to reduce the amount of entrained gas or foam present in such materials. These defoaming compositions may be used, for example, in cementing and drilling applications or construction applications.

In exemplary embodiments, a defoaming composition comprises one or more water soluble alkali salts and one or more defoaming agents.

According to exemplary embodiments, the water soluble alkali salts include one or more alkali salts such as, for example, borates, carbonates, bicarbonates, chlorides, phosphates, silicates, sulfates or mixtures thereof. The one or more salts may be salts of any alkali metal, for example sodium and potassium. The one or more salts may be salts of any alkaline earth metal, for example, magnesium, calcium, and strontium. In certain embodiments, the salts may be sodium, potassium, magnesium and calcium salts. In one embodiment, the water soluble alkali salt comprises one or more sodium salts, for example sodium bicarbonate, sodium chloride and/or sodium sulfate. In one embodiment, the water soluble alkali salt is sodium bicarbonate or a mixture comprising sodium bicarbonate. In one embodiment, the water soluble alkali salt is sodium chloride or a mixture comprising sodium chloride. In one embodiment, the water soluble alkali salt is sodium sulfate or a mixture comprising sodium sulfate. In another embodiment, the water soluble alkali salt is a mixture of sodium chloride and sodium sulfate, for example an approximately 50:50 mixture of sodium chloride and sodium sulfate.

According to exemplary embodiments, the defoaming agent can be any suitable defoaming agent known in the art. As used herein “defoaming agent” includes any of a number of compounds, mixtures or formulations that may prevent the formation of foam or reduce or destroy previously formed foam. Exemplary defoaming agents include silicone defoaming agents, non-silicone defoaming agents and/or mixtures thereof. In exemplary embodiments, the one or more defoaming agents can be: silicones; alkoxylated alcohols; ethylene oxide/propylene oxide (EO/PO) block copolymers; organic esters of EO/PO block copolymers, for example EO/PO block copolymer dioleate ester with or without hydrophobized silica; polydimethylsiloxanes (e.g., polydimethylsiloxane 100 cS, with hydrophobized silica and silicone surfactant); organic esters of polyethylene glycol; polypropylene glycol; mixtures of organic esters of polyethylene glycol and polypropylene glycol, for example polyethylene glycol dioleate and polypropylene glycol dioleate; hydrophobic silica; fatty alcohols and their esters, polypropylene glycols, polyethylene glycols; and mixtures thereof In one embodiment, the one or more defoaming agents are selected from the group consisting of EO/PO Block Copolymer Dioleate Ester, EO/PO Block Copolymer Dioleate Ester with Hydrophobized Silica, Polydimethylsiloxane+Hydrophobized Silica+Silicone Surfactant, Polyethylene Glycol Dioleate+Polyprolylene Glycol, and mixtures thereof.

In exemplary embodiments, the ratio of the weight of the one or more salts to the weight of the one or more defoaming agents in the defoaming composition is about 1:5 to about 1:100. In exemplary embodiments, the amount of the defoaming agents in the defoaming composition is about 0.01 to about 20%, about 1 to about 15%, about 5 to about 15%, about 5 to about 10% by weight of the defoaming composition. In exemplary embodiments, the amount of the defoaming agents in the defoaming composition is about 10% by weight of the defoaming composition.

In exemplary embodiments, the defoaming composition may comprise one or more hydrophobic solids. Exemplary hydrophobic solids include hydrophobic silica, aluminum stearate, talc, organically modified clay, aluminosilicate, mica, alumina, or mixture thereof In exemplary embodiments, the defoaming composition may comprise from about 0.1 to about 10 weight percent of the hydrophobic solids. The optional hydrophobic solids may enhance the performance of the defoamer composition.

In exemplary embodiments, the defoaming composition may optionally include one or more excipients or additives as necessary or desired. For example, an anti-caking agent may be added to prevent the formation of lumps and to further improve flowability, packaging and storage of dry defoaming compositions. Various inorganic or organic anti-caking agents may be used including but not limited to talc, calcium silicate, magnesium silicate, powdered cellulose, starch and such.

The exemplary defoaming compositions can be prepared by mixing or blending the defoaming agents with the water soluble alkali salts to form a dry powder composition. In an exemplary embodiment, the one or more defoaming agents are disposed on a surface of the one or more alkali salts. In an exemplary embodiment, the one or more defoaming agents are substantially homogeneously distributed over the surface of the one or more alkali salts. According to the exemplary embodiments, any suitable mixing method may be used to combine the one or more salts with the one or more defoaming agents. According to the embodiments, the one or more defoaming agents and one or more salts may be combined simultaneously, or sequentially in any order, or a combination thereof, to provide the defoaming composition. According to the embodiments, the optional excipients and/or additives may be added to the defoaming composition or a component thereof as necessary or desired.

In exemplary embodiments, a composition comprises a flowable material and a defoaming composition including one or more water soluble alkali salts and one or more defoaming agents. Examples of such “flowable materials” include but are not limited to: cements or cementitious materials, for example hydraulic cements; wellbore treatment fluids, including fluids used to drill, complete, work over, fracture, repair or the like; waste treatment compositions; water treatment compositions; or leaching compositions, for example leaching compositions for use in mining; mortars; fillers; putty; and adhesives. An exemplary wellbore is a wellbore that penetrates a subterranean formation. In one embodiment, the flowable material is a cement, for example hydraulic cement, and the composition optionally further comprises water. In another embodiment, the flowable material is a wellbore treatment fluid.

In exemplary embodiments, the composition includes an effective amount of the defoaming composition. An “effective amount” of the defoaming composition is that amount required to produce a necessary or desired defoaming result in the flowable material to which it is being introduced. The effective amount of defoaming composition for a particular flowable material can be readily determined by one of skill in the art. In exemplary embodiments, the defoaming composition is present in an amount of about 0.05 to about 2%, about 0.1 to about 1%, about 0.1 to about 0.5%, by weight of the flowable material, for example cement.

In exemplary embodiments, the composition may be prepared by adding the defoaming composition to the flowable material, or a component thereof. The defoaming composition can be added to a liquid or dry flowable material (or component thereof). For example, the defoaming composition may be added to the flowable material before, during, or after mixing or blending of the various components of the flowable material. In an exemplary embodiment, the defoaming composition may be added in dry form, liquid form (e.g., dissolved in a liquid), or as an emulsion as may be necessary or desired for the intended application. In exemplary embodiments, the defoaming composition is blended with one or more dry solids prior to mixing with other components of a composition. In exemplary embodiments, the defoaming composition is dissolved or mixed with liquid materials prior to or during mixing with other components of a composition. In exemplary embodiments, the defoaming composition can be added directly to water, aqueous media or other liquids prior or during the mixing and preparation of well treatment fluids or flowable materials.

In exemplary embodiments, a cement composition comprises one or more cements or cementitious materials, a defoaming composition, and water, wherein the defoaming composition comprises one or more water soluble alkali salts and one or more defoaming agents. The defoaming composition can be combined with one or more of the components of the cement composition before all of the components are combined. For example, the defoaming composition may be combined with the dry components of the cement or cementitious material, or it may be combined with the water. In other embodiments, the components of the cement composition may be combined simultaneously. In exemplary embodiments, the components of the cement composition are mixed or blended together to form the cement composition. For example, blending can occur at the pumphead, which displaces the cement composition down through the annulus of a wellbore (i.e. the area between a pipe in the wellbore and the wall of the wellbore) wherein it is allowed to set into a hard cement. In the cement compositions, the defoaming compositions may prevent or reduce the formation of foam during the preparation or pumping of the cement composition.

In exemplary embodiments, the cement or cementitious material can include, for example, hydraulic cement comprising calcium, aluminum, silicon, oxygen, and/or sulfur, which sets and hardens by reaction with water. Examples of hydraulic cements include but are not limited to Portland cements such as class A, B, C, G, and H Portland cements, pozzolana cements, gypsum cements, high alumina content cements, silica cements, high alkalinity cements, and combinations comprising at least one of the foregoing cements.

In exemplary embodiments, the water can include but is not limited to fresh water, an unsaturated aqueous salt solution, a saturated aqueous salt solution such as brine or seawater, and combinations comprising at least one of the foregoing.

In exemplary embodiments, the cement composition can include one or more additives as necessary or desired, such as additives for improving or changing the properties of the cement. Examples of such additives include but are not limited to set retarders, fluid loss control additives, dispersing agents (rheology modifiers), set accelerators, and formation conditioning agents. Other exemplary additives include bentonite and silica fume which can be introduced to the cement composition to prevent cement particles from settling.

The exemplary defoaming compositions may be used in combination with other flowable materials. For example, in an exemplary embodiment, a composition comprises a water-based fracturing fluid or a water-based drilling mud and a defoaming composition which includes one or more water soluble alkali salts and one or more defoaming agents. The defoaming agent is provided in an effective amount to prevent, destroy or reduce foam in the fracturing fluid or drilling mud, as necessary or desired. Such compositions are suitable for servicing e.g. oil and gas wells.

The exemplary defoaming compositions described herein can be used in methods for reducing the amount of gas present in a fluid, for example a flowable material.

In exemplary embodiments, a method for reducing an amount of entrained gas present in a flowable material comprises adding a defoaming composition to the flowable material to produce a composition. In the exemplary embodiments, the defoaming composition comprises one or more water soluble alkali salts and one or more defoaming agents. In exemplary embodiments, the resultant composition has reduced gas, or air, entrainment as compared to a similar flowable material that does not contain the defoaming composition.

In exemplary methods, the defoaming composition and the flowable material may be combined, blended, or mixed using any method. The defoaming composition can be added to a liquid or dry flowable material, or a component thereof. The defoaming composition may be added to the flowable material, or a component thereof, before, during, or after mixing or blending of the various components of the flowable material. In an exemplary embodiment, the defoaming composition may be added in dry form, liquid form (e.g., dissolved in a liquid), or as an emulsion as may be necessary or desired for the intended application. In exemplary embodiments, the defoaming compositions are blended with one or more dry solids prior to mixing with other components of a composition. In exemplary embodiments, the defoaming compositions is dissolved or mixed with liquid materials prior to mixing with other components of a composition. In another exemplary embodiment, the defoaming composition may be added to a slurry of flowable material. The defoaming compositions may be added to a flowable material that contains foam, or before the foam develops. In exemplary methods, one or more additional steps may be combined with the mixing step, as necessary or desired, to prevent, reduce or destroy foam in the flowable material.

In exemplary embodiments, a method for preventing foaming in cement or a cementitious material comprises adding a defoaming composition to the cement or cementitious material. The defoaming composition comprises one or more water soluble alkali salts and one or more defoaming agents. In certain embodiments, the defoaming composition is added to the cement or cementitious material (or a component thereof) prior to the addition of water or other liquid or fluid.

In exemplary embodiments, a method of cementing in a subterranean formation comprises displacing a cement composition into a subterranean formation, and allowing the cement composition to set. The cement composition comprises one or more hydraulic cements, water and a defoaming composition that includes one or more water soluble alkali salts and one or more defoaming agents. In certain embodiments, displacing the cement composition comprises pumping the cement composition into an annular space between walls of a well bore and a casing during a primary or remedial cementing operation. In certain embodiments, the hydraulic cement and water are mixed and foamed and the defoaming composition is added to the hydraulic cement and water mixture in an amount effective to break the foam, thereby reducing gas entrainment in the cement composition.

The following examples are presented for illustrative purposes only, and are not intended to limit the scope of the invention.

### EXAMPLES

### Example 1

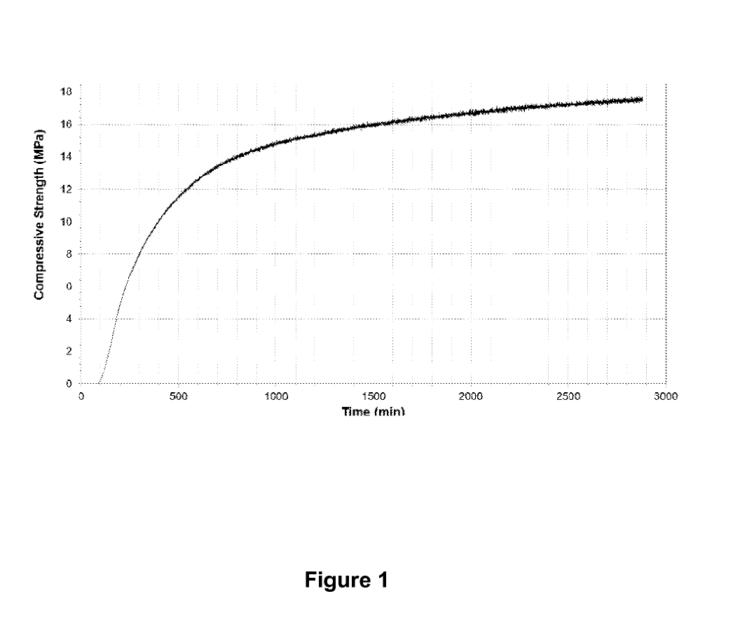

In this example, the compressive strength was measured for cement compositions with and without a defoaming composition. In each sample, the cement composition is API class A cement. The solid defoaming composition used in this example was a diesterification product of oleic acid with a primary hydroxyl terminated polyoxyethylene-polyoxypropylene block copolymer (generally designated as EO/PO DO) with an average molecular weight of about 2,000 Daltons deposited on the mixture of sodium chloride-sodium sulfate (50:50). The cement and the defoaming composition were dry-blended before water was added to the composition to provide a cement composition with a density of 1800 kg/m³. Compressive strength data up to 48 hours for API class A cements at a density of 1800 kg/m³ are given in Table 1. Compressive strength testing was carried out on CTE Model 2000-5 Ultrasonic Cement Analyzer according to test standard API RP 10B-2 (Recommended Practice for Testing Well Cements) operating at 4000 psi pressure. The results show that cement composition containing the defoamer composition met the standard requirements (minimum strength of 3.5 MPa after 48 hours) for compressive strength. In addition, the results show that a cement composition including the defoaming composition can be used to create cement blends without retarding cement hydration. FIG. 1 shows the compressive strength development as a function of time for API class A cement slurry with 0.2% (BWOC—By Weight Of Cement) of the powder defoamer used in this example (SPD#1).

TABLE 1
Compressive strength data

| | | | Defoaming | Compressive Strength (MPa) | | | |
|---|---|---|---|---|---|---|---|
| | Density | BHST | composition | 8 | 16 | 24 | 48 |
| Blend | (Kg/m³) | (° C.) | (wt %) | hrs | hrs | hrs | hrs |
| Cem A | 1800 | 50 | 0 | 10.4 | 14.3 | 15.7 | 17.6 |
| Cem A | 1800 | 50 | 00.2% | 11.3 | 14.6 | 15.9 | 17.5 |

BHST: Bottom Hole Static Temperature
Cem A = API class A Cement

### Example 2

In this example, defoaming characteristics were examined for various powder defoaming compositions at various dosages, in cement compositions. In this example, the cementitious materials used were API class cement A slurries containing 2% by weight of cement (BWOC) of a sodium lignosulfonate (Norlig 12F, Lignotech USA Inc.) rheology modifier additive. The defoaming composition chemistries are listed in Table 2. Densities were measured immediately after the slurry was prepared (using standard API RP 10B-2 procedure) using a graduated cylinder and weight of the slurry. Data are summarized in Table 3. All defoaming compositions tested were found to be effective for reducing air entrainment when added at 0.1-0.4% BWOC.

TABLE 2
Water Soluble Powder Defoamers

| | | Active Defoaming Composition |
|---|---|---|
| Defoamer | Solid Carrier | (10% By Weight of Solid) |
| SPD#1 | Sodium Chloride − | EO/PO Block Copolymer Dioleate Ester with |
| | Sodium Sulfate (50:50) | Hydrophobized Silica |
| SPD#2 | Sodium Bicarbonate | EO/PO Block Copolymer Dioleate Ester with |
| | | Hydrophobized Silica |
| SPD#3 | Sodium Chloride − | EO/PO Block Copolymer Dioleate Ester |
| | Sodium Sulfate (50:50) | |
| SPD#4 | Sodium Bicarbonate | EO/PO Block Copolymer Dioleate Ester |
| SPD#5 | Sodium Bicarbonate | Polydimethylsiloxane (100 cS) + Hydrophobized |
| | | Silica + Silicone Surfactant |
| SPD#6 | Sodium Chloride − | Polyethylene Glycol Dioleate + |
| | Sodium Sulfate (50:50) | Polyprolylene Glycol |
| SPD#7 | Sodium Bicarbonate | Polyethylene Glycol Dioleate + Polyprolylene Glycol |

TABLE 3
Defoamer performance based on API Class A cement slurries
density (kg/m³) as a function of defoamer dosage.

| Defoamer | 0.1% BWOC | 0.2% BWOC | 0.3% BWOC | 0.4% BWOC |
|---|---|---|---|---|
| NONE | 1095* | — | — | — |
| SPD#2 | 1541 ± 10 | 1581 ± 10 | 1579 ± 10 | 1572 ± 10 |
| SPD#4 | 1575 ± 10 | 1578 ± 10 | 1583 ± 10 | 1619 ± 10 |
| SPD#5 | 1541 ± 10 | 1575 ± 10 | 1579 ± 10 | 1602 ± 10 |

*Designed density = 1650 kg/m³

### Example 3

In this example, defoaming characteristics were examined for various powder defoaming compositions at various dosages, in cement compositions. In each sample, the cementitious material was API class cement A slurry containing 1% by weight of cement (BWOC) of a sodium lignosulfonate (Norlig 12F, Lignotech USA Inc.) rheology modifier additive, prepared with a 20% (BWOW—By Weight Of Water) sodium chloride brine solution. The defoaming composition chemistries used in the samples are listed in Table 2. Cement dispersants (rheology modifiers) are generally thought to cause foaming in cement-brine slurries. Densities of each of the samples were measured immediately after the slurry was prepared (using standard API RP 10B-2 procedure) using a graduated cylinder and weight of the slurry. Data are summarized in Table 4. The results show that all exemplary defoaming compositions tested were effective at reducing air entrainment in the cement compositions when added at 0.1-0.4% BWOC.

TABLE 4
Defoamer performance based on API Class A cement slurries
density (kg/m³) as a function of dosage.

| Defoamer | 0.1% BWOC | 0.2% BWOC | 0.3% BWOC | 0.4% BWOC |
|---|---|---|---|---|
| NONE | 1073.5* | — | — | — |
| SPD#1 | 1310.8 ± 10 | 1419.4 ± 10 | 1490.3 ± 10 | 1496.3 ± 10 |
| SPD#2 | 1334.3 ± 10 | 1470.3 ± 10 | 1521.6 ± 10 | 1525.3 ± 10 |
| SPD#3 | 1330.0 ± 10 | 1438.0 ± 10 | 1492.1 ± 10 | 1522.1 ± 10 |
| SPD#4 | 1362.9 ± 10 | 1415.8 ± 10 | 1485.2 ± 10 | 1525.4 ± 10 |
| SPD#6 | 1378.4 ± 10 | 1514.9 ± 10 | 1588.7 ± 10 | 1617.6 ± 10 |
| SPD#7 | 1409.5 ± 10 | 1525.9 ± 10 | 1579.5 ± 10 | 1620.9 ± 10 |

*Designed density = 1650 kg/m³

### Example 4

In this example, defoaming characteristics were examined for various liquid and powder defoaming compositions, in cement compositions. In each sample, the cementitious material was API class cement A slurries containing 1% by weight of cement (BWOC) of a sodium lignosulfonate (Norlig 12F, Lignotech USA Inc.) rheology modifier, prepared using a 20% (BWOW) sodium chloride brine solution. The defoaming composition chemistries are listed in Table 5. Powder defoamers were obtained by deposition of 10, 20 or 30% (by weight of solid—as indicated in Table 6) of active defoaming agent on precipitated silica (SIPERNAT® 22, available from Evonik Industries AG). All powder defoamers were added to the cement compositions at 0.2 g (0.1% BWOC), while liquid defoamers are added at 25, 50 or 75 μL, to provide active defoaming component dosage amounts equivalent to the powder defoamer. Densities were measured immediately after the slurry was prepared (using standard API RP 10B-2 procedure) using a graduated cylinder and weight of the slurry. The data (Table 6) shows that at the time tested, the liquid defoamer performance was higher than the equivalent solid defoamer performance, indicating that the active defoaming agent is slowly (and partially) released from the precipitated silica.

TABLE 5
Liquid and Powder Defoaming Compositions

| | Solid | Active Defoaming Composition |
|---|---|---|
| Defoamer | Carrier | (10% By Weight of Solid) |
| LD#1 | — | EO/PO Block Copolymer Dioleate Ester with |
| | | Hydrophobized Silica |
| PD#1 | Precipitated | EO/PO Block Copolymer Dioleate Ester with |
| | Silica | Hydrophobized Silica |
| LD#2 | — | Polyethylene Glycol Dioleate + |
| | | Polyprolylene Glycol |
| PD#2 | Precipitated | Polyethylene Glycol Dioleate + |
| | Silica | Polyprolylene Glycol |

TABLE 6
Defoamer performance based on API Class A cement slurries density
(kg/m³) as a function of active defoaming composition and dosage

| Defoamer | 10% Active | 20% Active | 30% Active |
|---|---|---|---|
| NONE | 1073.5* | — | — |
| LD#1 | 1365.3 ± 10 | 1460.1 ± 10 | 1488.4 ± 10 |
| PD#1 | 1151.9 ± 10 | 1271.5 ± 10 | 1296.7 ± 10 |
| LD#2 | 1127.7 ± 10 | 1434.7 ± 10 | 1528.3 ± 10 |
| PD#2 | 1133.9 ± 10 | 1165.3 ± 10 | 1379.2 ± 10 |

*Designed density = 1650 kg/m³

### Example 5

In this example, defoaming characteristics were examined for various liquid and powder defoaming compositions in cement compositions. In each sample, the cementitious material was API class cement A slurry containing 1% by weight of cement (BWOC) of a sodium lignosulfonate (Norlig 12F, Lignotech USA Inc.) rheology modifier, prepared using a 20% (BWOW) sodium chloride brine solution. The defoaming composition chemistries are listed in Table 2 or Table 5. Powder defoamers were obtained by deposition of 10% (by weight of solid) of active defoaming chemistry on a mixture of sodium chloride-sodium sulfate (50:50). All powder defoamers were added at 0.1%-0.4% BWOC (as indicated in table 7), while liquid defoamers were added at 25, 50, 75, or 100 μL, to provide active defoaming component dosage amounts equivalent to the powder defoamer. Densities of the cement samples were measured immediately after the slurry was prepared (using standard API RP 10B-2 procedure) using a graduated cylinder and weight of the slurry. The data (Table 7) shows that equivalent performance of the liquid and powder defoamer compositions, indicating the fast and complete release of active defoamer from powder compositions.

TABLE 7
Defoamer performance based on API Class A cement slurries
density (kg/m³) as a function of defoamer dosage.

| Defoamer | 0.1% BWOC | 0.2% BWOC | 0.3% BWOC | 0.4% BWOC |
|---|---|---|---|---|
| NONE | 1073.5* | — | — | |
| LD#1 | 1365.3 ± 10 | 1460.1 ± 10 | 1488.4 ± 10 | 1511.0 ± 10 |
| SPD#1 | 1310.8 ± 10 | 1419.4 ± 10 | 1490.3 ± 10 | 1496.3 ± 10 |
| LD#2 | 1327.7 ± 10 | 1434.7 ± 10 | 1528.3 ± 10 | 1555.6 ± 10 |
| SPD#6 | 1378.4 ± 10 | 1514.9 ± 10 | 1588.7 ± 10 | 1617.6 ± 10 |

*Designed density = 1650 kg/m³

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A defoaming composition comprising one or more water soluble alkali salts and one or more defoaming agents.

2. The defoaming composition of claim 1, wherein the water soluble alkali salts are selected from borates, carbonates, chlorides, phosphates, silicates, sulfates or mixtures thereof

3. The defoaming composition of claim 1, wherein the water soluble alkali salts are selected from sodium, potassium, magnesium and calcium salts.

4. The defoaming composition of claim 1, wherein the water soluble alkali salts are selected from sodium bicarbonate, sodium chloride and sodium sulfate.

5. The defoaming composition of claim 1, wherein the defoaming agents are selected from silicone defoaming agents, non-silicone defoaming agents, and mixtures thereof

6. The defoaming composition of claim 5, further comprising a hydrophobic solid.

7. The defoaming composition of claim 6, wherein the hydrophobic solid is a hydrophobic silica, aluminum stearate, talc, organically modified clay, aluminosilicate, mica, alumina, or mixture thereof

8. The defoaming composition of claim 6, wherein the defoaming composition comprises from about 0.1 to about 10 weight percent of the hydrophobic solid.

9. The defoaming composition of claim 5, wherein the defoaming agents are selected from: silicones; alkoxylated alcohols; ethylene oxide/propylene oxide (EO/PO) block copolymers; organic esters of EO/PO block copolymers; polysiloxanes; organic esters of polyethylene glycol; polypropylene glycol; mixtures of organic esters of polyethylene glycol and polypropylene glycol; hydrophobic silica; and mixtures thereof

10. The defoaming composition of claim 9, wherein the defoaming agents are selected from: EO/PO Block Copolymer Dioleate Ester, EO/PO Block Copolymer Dioleate Ester with Hydrophobized Silica, Polydimethylsiloxane+Hydrophobized Silica+Silicone Surfactant, Polyethylene Glycol Dioleate+Polyprolylene Glycol, and mixtures thereof

11. A composition comprising a flowable material and a defoaming composition, wherein the defoaming composition comprises one or more water soluble alkali salts and one or more defoaming agents.

12. The composition of claim 11, wherein the flowable material is selected from cements or cementitious materials; wellbore treatment fluids; waste treatment compositions; water treatment compositions; leaching compositions; mortars; fillers; putty; and adhesives.

13. The composition of claim 11, wherein the flowable material is a hydraulic cement and the composition further comprises water.

14. A method for reducing an amount of entrained gas present in a flowable material, wherein the method comprises adding a defoaming composition to the flowable material, wherein the defoaming composition comprises one or more water soluble alkali salts and one or more defoaming agents.

15. The method of claim 14, wherein the method further comprises reducing gas entrainment in the flowable material composition relative to a flowable material composition without the defoaming composition.

16. A method for preventing foaming in cement or a cementitious material, wherein the method comprises adding a defoaming composition to the cement or cementitious material, wherein the defoaming composition comprises one or more water soluble alkali salts and one or more defoaming agents.

17. The method of claim 16, wherein the defoaming composition is added prior to the addition of water or other liquid or fluid.

18. A method of cementing in a subterranean formation, wherein the method comprises displacing a cement composition into a subterranean formation, wherein the cement composition comprises one or more hydraulic cements, water and a defoaming composition comprising one or more water soluble alkali salts and one or more defoaming agents; and
allowing the cement composition to set.

19. The method of claim 18, wherein displacing the cement composition comprises pumping the cement composition into an annular space between walls of a well bore and a casing during a primary or remedial cementing operation.

20. The method of claim 18, wherein hydraulic cement and water are mixed and foamed and the defoaming composition is added to the hydraulic cement and water mixture in an amount effective to break the foam.
